(19) United States
(12) Patent Application Publication
(10) Pub. No.: US 2025/0373650 A1
(43) Pub. Date: Dec. 4, 2025

(54) Attack Mitigation for Artificial Intelligence and Machine Learning Systems

(71) Applicant: Styrk Inc., Fremont, CA (US)

(72) Inventors: Vilayannur Ramachandran Sitaraman, Seattle, WA (US); Anhad Preet Singh, Pittsburg, CA (US); Meenakshi Kumar, Fremont, CA (US)

(21) Appl. No.: 19/221,071

(22) Filed: May 28, 2025

Related U.S. Application Data
(60) Provisional application No. 63/653,016, filed on May 29, 2024.

(51) Int. Cl. H04L 9/40

(52) U.S. Cl. CPC H04L 63/1441

(57) ABSTRACT

Systems and methods for performing attack mitigation in one or more artificial intelligence (AI)-based systems are disclosed. One aspect includes receiving data to be analyzed by an AI system. The data may be perturbed by an attack. A counterattack on the data may be performed as a part of an attack mitigation. In one aspect, the counterattack comprises further perturbing the data.

This application claims the priority benefit of provisional patent application No. 63/653,016 titled “Attack Mitigation for Artificial Intelligence and Machine Learning Systems” filed on May 29, 2024, the disclosure of which is incorporated by reference herein in its entirety.

### BACKGROUND

### Technical Field

The present disclosure relates to systems and methods configured to implement attack mitigation on data that is input to one or more artificial intelligence (AI) systems for processing. Such attack mitigation is intended to reduce or eliminate any adverse effects of an attack or perturbation on such data by a nefarious party.

### Background Art

Systems and methods incorporating artificial intelligence (AI) and machine learning (ML) have seen increasing levels of deployment over the years. Applications of AI and ML systems include analyzing data and drawing one or more inferences (e.g., classifying the data) based on the analysis. The proliferation of AI and ML systems has also led to nefarious parties attempting to attack these systems and cause errors in the associated inferencing processes. Some attacks directly manipulate, or perturb, input data to an AI/ML system in a manner such that the perturbation is imperceptible. However, such a perturbation can cause the associated AI/ML model to misclassify the data, leading to erroneous output results.

### SUMMARY

Aspects of the invention are directed to systems and methods for mitigating or eliminating adverse effects of one or more attacks on data to be input to an AI/ML system or AI/ML model for analysis. One aspect includes receiving data to be analyzed by an AI/ML system or model. The data may be perturbed by an attack. The method my include performing a counterattack on the data as a part of an attack mitigation. In one aspect, the counterattack includes further perturbing the data. The counterattack may be a fast gradient sign method (FGSM) attack. In one aspect, the counterattack increases a loss on one or more incorrect labels in the data, thereby compensating for mislabeling in the data caused by the perturbation due to the attack.

In one aspect, a nature of the attack is unknown. An embodiment may include detecting the perturbation due to the attack in the data, and performing the counterattack responsive to the detecting. The counterattack may be agnostic to a nature or a type of the attack. Other aspects include computer systems and/or apparatuses that implement the above method.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a computer system architecture configured to process data using an AI system/model as described in the prior art.

FIG. 2 is a block diagram depicting a computer system architecture configured to perform attack mitigation.

FIG. 3 is a flow diagram of a method to perform attack mitigation.

FIG. 4 is a block diagram of a processing system architecture.

FIG. 5 is a graph presenting a comparison between a performance of an attack mitigation system and a performance of existing defense mechanisms.

FIG. 6 is a three-dimensional (3D) graph presenting a comparison between a performance of an attack mitigation system and a performance of existing defense mechanisms.

FIG. 7 is a graph presenting accuracy differences by defense for a basic iterative method (BIM) and an FGSM attack mitigation method.

FIG. 8 is a graph presenting accuracy differences by defense for a Carlini LO method and an FGSM attack mitigation method.

FIG. 9 is a graph presenting accuracy differences by defense for a universal perturbation and an FGSM attack mitigation method.

FIG. 10 is a graph presenting accuracy differences for different preexisting defenses.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to providing attack mitigation techniques on data to be processed by one or more AI systems/models. In one aspect, the data may be perturbed by an attacker. A corresponding counterattack may be implemented as a part of an attack mitigation strategy by the systems and methods described herein. In one aspect, the counterattack includes performing an attack on the perturbed data (e.g., further perturbing the data as a part of the counterattack). This subsequent attack/perturbation by the counterattack effectively reduces or eliminates any deleterious effects of the original attack by the attacker. As described herein, the terms “AI system(s)” and “AI model(s)” generally include the class of AI/ML-based computing systems and associated AI/ML models.

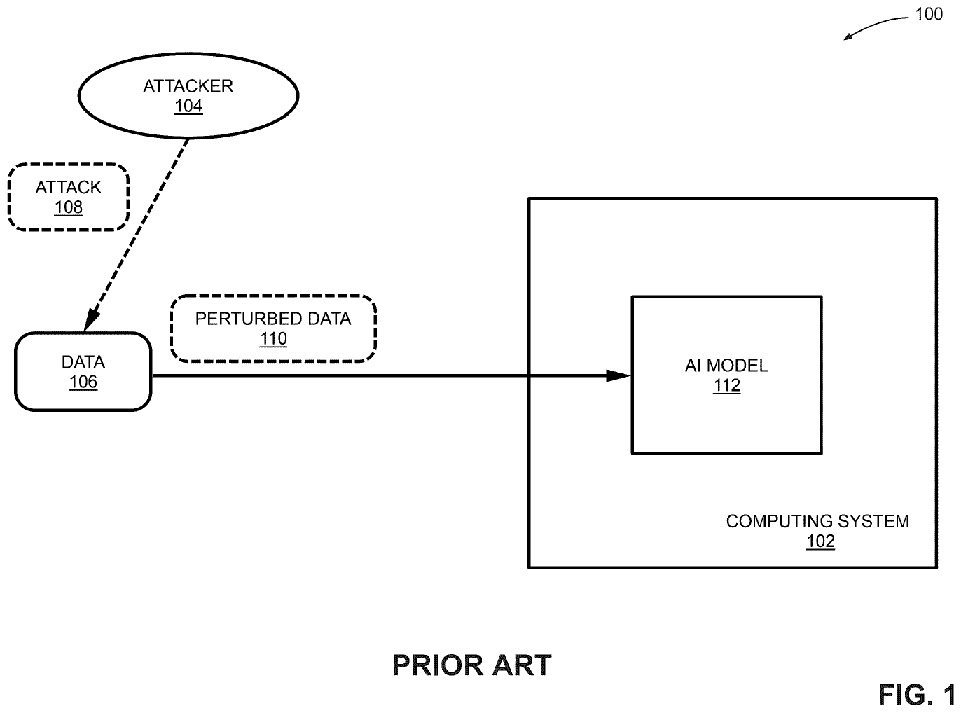

FIG. 1 is a block diagram depicting a computer system architecture 100 configured to process data using an AI system/model as described in the prior art. As depicted, computer system architecture 100 includes processing system 102 running AI model 112. AI model 112 may be configured to process data 106 as a part of system operation. The processing of data 106 by AI system 112 may include drawing one or more inferences or classifications based on the processing.

An attacker 104 may perturb the data via an attack 108 to generate perturbed data 110. Hence, the AI model 112 now receives perturbed data 110 instead of data 106 due to the attack 108. The perturbation may be imperceptible, but may cause the AI model 112 to misclassify the data. At the time of writing, there are around 35 different kinds of evasion attacks that can be executed on data that can cause an AI model (such as AI model 112) to perform a misclassification on the data.

Current approaches to mitigate the effects of such perturbation attacks include implementing one or more defense mechanisms. The objective of a defense mechanism is to reduce the effect of the attack, reduce the extent of the misclassification, and increase the resulting accuracy. At the time of writing, there are at least 15 known defenses, each of which can be parameterized with combinations of one or more associated parameters. If multiple defense mechanisms are simultaneously used, the possible combinations of parameters and defense mechanisms can be in the hundreds. Also, the existing approach of using one or more defense mechanisms has the following disadvantages:
Not all defenses work for all attacks.
Changing the parameters of a defense strategy can have a large impact on how well the defense strategy works for a particular attack. In other words, mitigating an attack may require extensive iteration over a large number of parameters in order to achieve a satisfactory attack mitigation result.
There is a combinatorial explosion of an attack-defense-parameters mix-if multiple defense strategies are employed, the resultant combinatorial trade space of parameters can increase significantly, to the extent that determining a suitable attack mitigation strategy may be time- and resource-intensive, or even infeasible.
Currently, there is no known way to discern which attack the input has been perturbed with, even if it is determined that an attack has occurred.
While the complexity of a combination of defenses can be very large, the effectiveness of such combinations of defenses is not additive in terms of overall effectiveness. Rather, in a lot of cases, such combinations can result in a decrease in accuracy.
Time- and compute-resource consumption/allocation to implement all defenses can be significant, and a disadvantage in that sense.

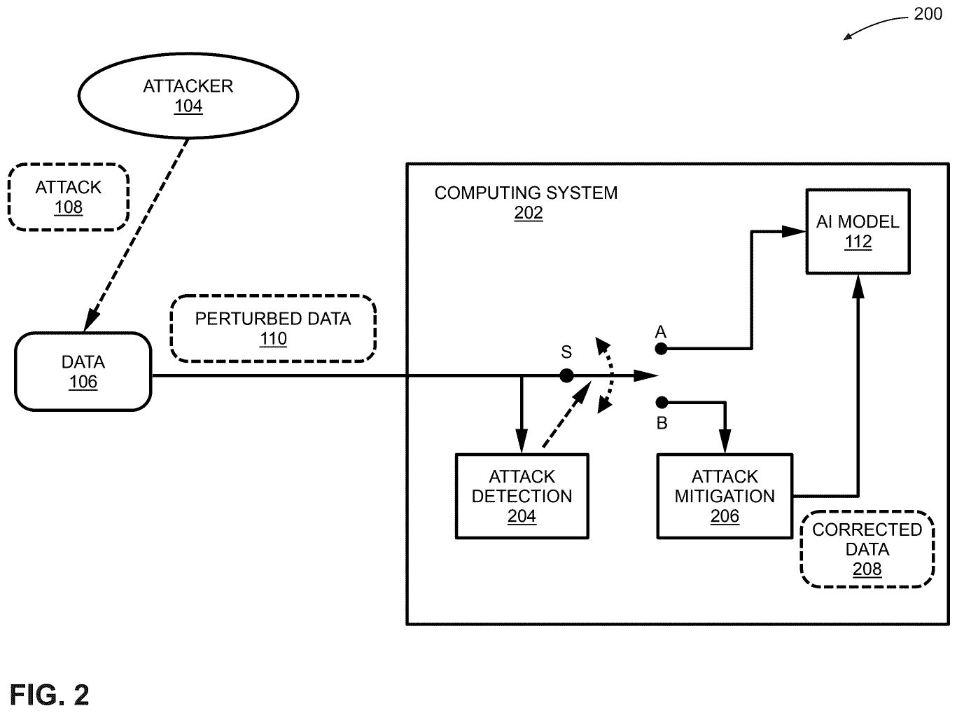

FIG. 2 is a block diagram depicting a computer system architecture 200 configured to perform attack mitigation. As depicted, computer system architecture 200 includes computing system 202 running AI model 112. Computing system 202 also includes attack detection 204 and attack mitigation 206.

In an aspect, AI model 112 is configured to process data 106 as a part of system operation. The processing of data 106 by AI system 112 may include drawing one or more inferences or classifications based on the processing.

An attacker 104 may perturb the data via an attack 108, to generate perturbed data 110. Attack detection system 204 may continuously analyze all data received by computing system 202, including unperturbed data 106 (in an absence of an attack), and/or perturbed data 110. Attack detection system 204 may analyze the data being received by computing system 202 to determine whether an attack has occurred, and whether the data 106 has been transformed to perturbed data 110.

In an aspect, If the data is not perturbed, then the attack detection system 204 configures switch S to engage option A, which inputs (unperturbed) data 106 into the AI model 112 for analysis. On the other hand, if the data is perturbed (i.e., perturbed data 110), then the attack detection system 204 configures switch S to engage option B, which routes the perturbed data through attack mitigation 206.

Attack mitigation 206 is configured to mitigate or eliminate the effects of the data perturbation in the perturbed data 110, thereby reducing the extent of, or even eliminating, any misclassifications by AI model 112. In an aspect, attack mitigation 206 intercepts and attempts to correct the perturbed data 110 before it is analyzed by the AI model 112.

In one aspect, attack mitigation 206 implements the attack mitigation by performing an attack (e.g., a subsequent attack-a counterattack) on the perturbed data 110, where the subsequent attack (counterattack) is a mitigation attack that essentially reduces, negates, or eliminates the effect of the original attack 108 by the attacker 104. The mitigation attack/counterattack may be, for example, selected to be a Fast Gradient Sign Method (FGSM) attack, which is effective against a wide range of attack-defense parameter combinations.

The effectiveness of the attack mitigation implemented by attack mitigation 206 is based on understanding the nature of an attack. An attack perturbs the data such that the model (e.g., AI model 112) generates an incorrect prediction. In an aspect, an FGSM attack is executed as a counterattack by obtaining gradients of the loss after the associated counterattack perturbation and determining a counterattack perturbation that maximizes the associated loss. To calculate the loss, the ground truths or the model prediction are/is used. When FGSM is applied on an attacked data as a counterattack, the FGSM counterattack essentially increases a loss on the wrong labels. This is exactly what a correctly-functioning training mechanism should do for AI model 112; hence the FGSM counterattack ends up correcting the data.

In an aspect, the FGSM counterattack (or any other counterattack/attack mitigation strategy implemented by attack mitigation 206) is implemented without a knowledge of what kind of attack 108 has been used by attacker 104. In that sense, the attack mitigation strategy (e.g., the FGSM counterattack) as implemented by attack mitigation 206 is agnostic to the nature, type, or kind of attack 108.

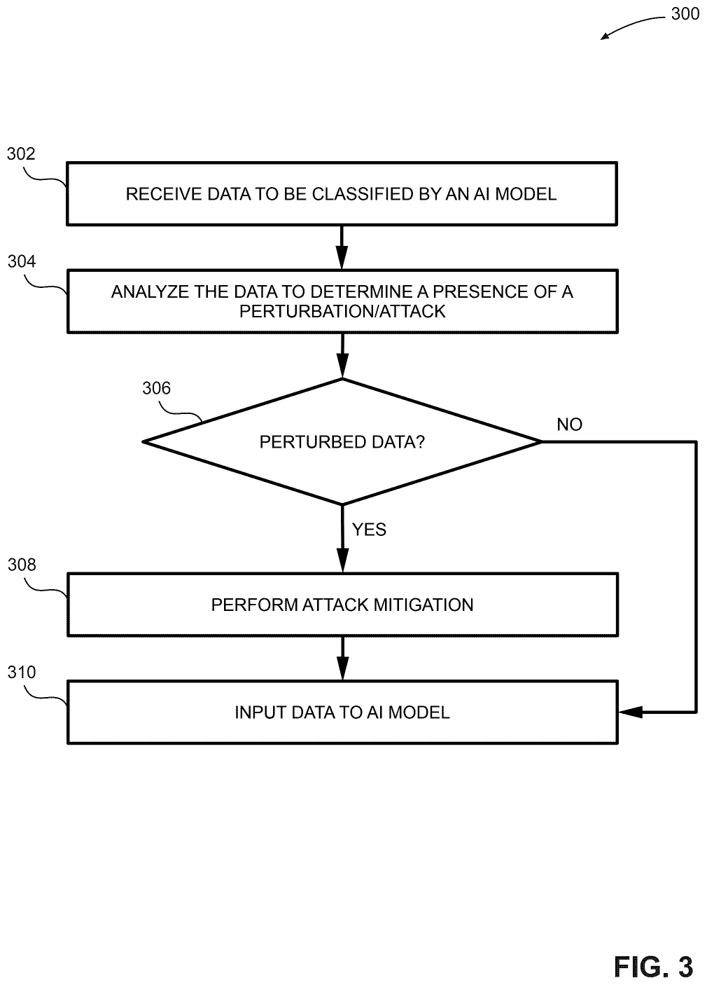

FIG. 3 is a flow diagram of a method 300 to perform attack mitigation. Method 300 may be implemented on computing system 202. Aspects of method 300 may be implemented by attack detection 204 and attack mitigation 206.

Method 300 may include receiving data to be classified by an AI model (or system) (302). For example, computing system 202 may receive data 106 (or perturbed data 110) to be classified by AI model 112.

Method 300 may include analyzing the data to determine a presence of a perturbation or an attack (304). For example, attack detection 204 may be configured to analyze the data to determine whether data 106 has been perturbed as perturbed data 110.

At 306, if the data is not perturbed, then method 300 may input the data to an AI model (310). For example, attack detection 204 may configure switch S to engage option A, which directly routes data 106 to AI model 112.

On the other hand, at 306, if the data is perturbed, then method 300 may perform attack mitigation (308). For example, attack detection 204 may configure switch S to engage option B, which routes perturbed data 110 to attack mitigation 206. Attack mitigation 206 may then perform attack mitigation. In one aspect, the attack mitigation is performed by attack mitigation 206 via a counterattack that attacks perturbed data 110 using, for example, the FGSM counterattack. The attack mitigation process may be performed agnostic of the nature of attack 108. Attack mitigation 206 may then transmit corrected data 208 (post-attack mitigation) to AI model 112 (310).

An analogy can be drawn between the attack mitigation algorithm (i.e., method 300) and biological antigen defense. In biological systems, antigen therapy works by triggering an immune system to produce antibodies that destroy the invading proteins. In the case of the AI system (e.g., AI model 112), the AI model and associated data combination can be considered as a living system. In one aspect, the data can be considered as cells, while the perturbations are foreign proteins that attack the “cells”. The corresponding labels associated with AI classification can be considered as being analogous to biological proteins.

In a biological system, an attack causes the labels to change, i.e., antibodies are produced. When applied to a cell which has already been attacked, these antibodies bind to the foreign antibodies. Essentially, the new predicted labels change the original (attacked data) predicted labels to the correct ones by, for example, the FGSM counterattack. This happens by adjusting the weights of the model in the correct direction. In this sense, the counterattack executed by an attack mitigation system (e.g., attack mitigation 206) can be viewed as being similar to an antigen defense mechanism seen in biological systems. Accordingly, counterattack and attack mitigation strategies as deployed/implemented by attack mitigation 206 may also be referred to herein as “antigen defense” or “antigen defense mechanisms”.

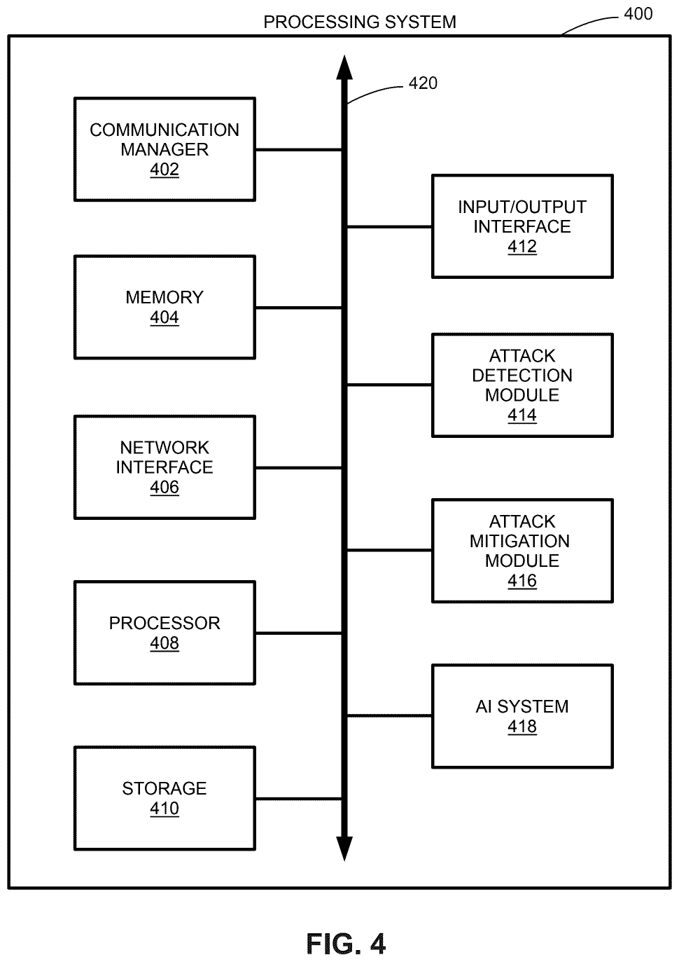

FIG. 4 is a block diagram of a processing system architecture 400. As depicted, processing system architecture includes communication manager 402, memory 404, network interface 406, processor 408, storage 410, input/output interface 412, attack detection module 414, attack mitigation module 416, AI system 418, and system bus 420.

Processing system 400 may be used to implement aspects of the systems and methods described herein. For example, processing system 400 can be used as a basis for implementing aspects of computing system 202.

In an aspect, communication manager 402 is configured to manage communication protocols and associated communication with external peripheral devices as well as communication with other components in computing system 202. For example, communication manager 402 may be responsible for generating and maintaining respective communication interfaces between computing system 202 and a source of data 106.

In an aspect, memory 404 includes a non-transitory computer medium. Memory 404 may be comprised of any combination of volatile and non-volatile memory components. Examples of components that may be used to implement memory 404 include random-access memory (RAM), read-only memory (ROM), electrically-erasable programmable read-only memory (EEPROM), flash memory, magnetic memory, optical memory, and so on. Memory 404 may include machine-readable instructions that may be executable by a processor such as processor 408. These machine-readable instructions when executed by the processor 408 cause the processor 408 to perform one or more method steps of an embodiment described herein.

Network interface 406 may be used to interface processing system 400 (e.g., computing system 202) with other computing devices and/or computer networks. Examples of computer networks include a local area network (LAN), a wide area network (WAN), the Internet, and so on. Network interface 406 support any combination of wired and wireless connectivity/communication protocols such as Ethernet, Wi-Fi, Bluetooth, ZigBee, etc.

A processor 408 included in some embodiments of processing system 400 is configured to perform functions that may include generalized processing functions, arithmetic functions, and so on. Processor 408 is configured to process information associated with the systems and methods described herein. Processor 408 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 408 may be embodied as a single-core processor, or a multi-core processor. Processor 408 may be implemented as a centralized processor, or in a distributed manner (e.g., a distributed computing system).

Processing system 400 may include storage 410, that further includes one or more long-term storage devices such as hard disk drives, magnetic drives, magnetic tape, optical storage media (e.g., compact disks (CDs) or digital versatile disks (DVDs)), and so on. Storage 410 may be implemented as a non-transitory computer-readable medium. Storage 410 may be configured to store data and/or instructions related to the operation of processing system 202. For example, AI model 112 may be stored on storage 410, and accessed via memory 404. Similarly, data 106 may be stored on storage 410, for access by AI model 112.

Input/output interface 412 allows other devices or a user to interact with embodiments of the systems described herein. Input/output interface 412 may include any combination of user interface devices such as a keyboard, a mouse, a trackball, one or more visual display monitors, touch screens, incandescent lamps, LED lamps, audio speakers, buzzers, microphones, push buttons, toggle switches, and so on. Input/output interface 412 may alco include interfaces such as USB, Thunderbolt and FireWire that enable processing system 400 to interface with different devices.

Attack detection module 414 may be configured to determine whether received data (e.g., data received by computing system 202) is perturbed (e.g., as perturbed data 110). Attack detection module 414 may be similar in functionality to attack detection 204.

Attack mitigation module 416 may be configured to perform attack mitigation on perturbed data (e.g., perturbed data 110) based on the systems and methods described herein. Attack mitigation module 418 may be similar in functionality to attack mitigation 206.

AI system 418 may be configured to process data (e.g., data 106), and draw one or more inferences or conclusions based on the processing. AI system 418 may be similar to AI model 112.

System bus 420 communicatively couples the different components of processing system 400, and allows data and communication messages to be exchanged between these different components.

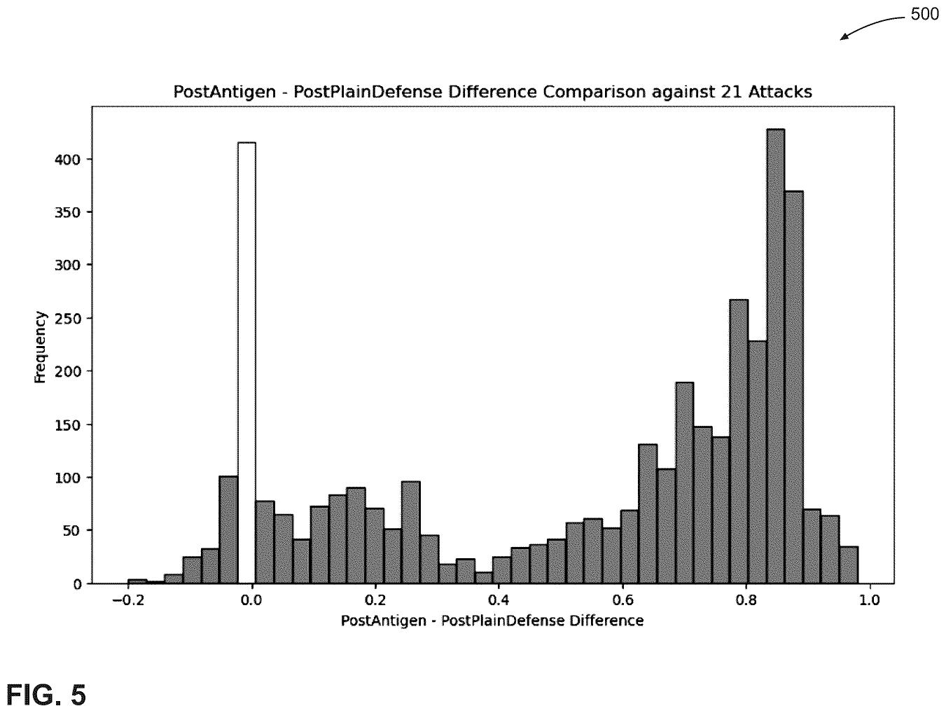

FIG. 5 is a graph 500 presenting a comparison between a performance of an attack mitigation system implemented using the systems and methods described herein, and a performance of existing defense mechanisms. FIG. 5 depicts a difference between accuracy post antigen defense (i.e., post-attack mitigation by attack mitigation 206) minus the accuracy after using a traditional defense for a variety of attack-defense combinations. The Y-axis is a number of such attack-defense combinations exhibiting a difference that lies in a corresponding bucket on the X-axis. Note that a positive difference implies that the antigen defense (i.e., an attack mitigation strategy implemented by attack mitigation 206) results in a better accuracy compared to that of the traditional defense. The higher the difference (i.e., the further to the right a bar is), the better the antigen defense performs compared to the traditional attack. All the dark-colored bars to the right of 0.0 on the X-axis indicate the scenarios where the antigen defense performs better than the traditional attack (better accuracy). The antigen defense therefore, outperforms a significant fraction of the traditional defense strategies across the board, for a variety of attacks. This means that a single antigen defense can be employed oblivious to (i.e., agnostic of) the kind of attack, which solves the problems in selecting a suitable defense alluded to earlier. In other words, the FGSM counterattack can be implemented when an attack is detected, without having to determine a nature or a kind of the attack.

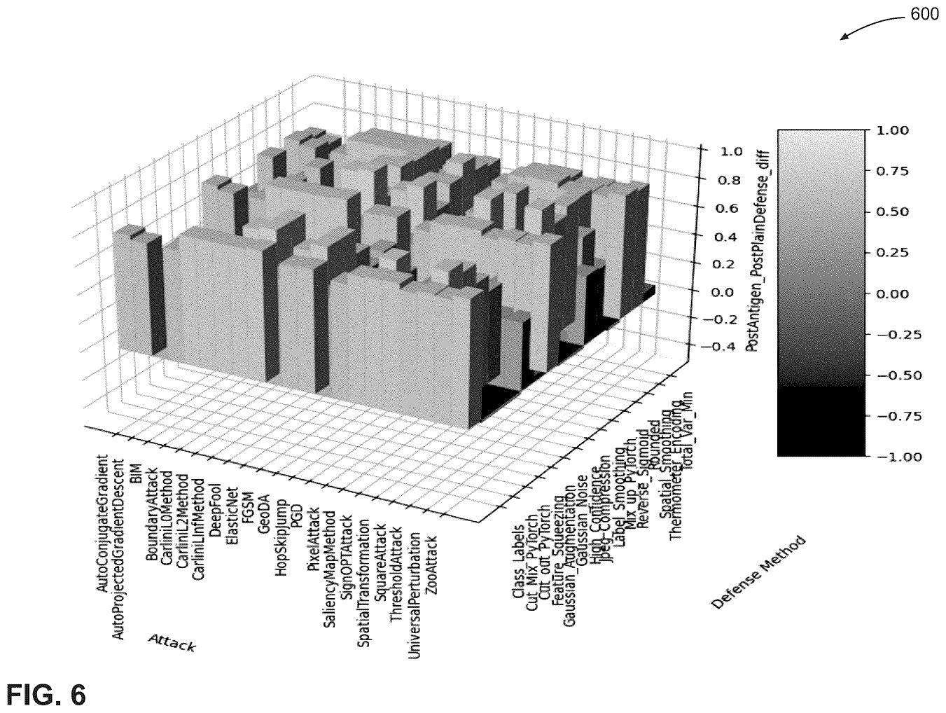

FIG. 6 is a three-dimensional (3D) graph 600 presenting a comparison between a performance of an attack mitigation system implemented using the systems and methods described herein, and a performance of existing defense mechanisms. FIG. 6 depicts a variety of attacks and a variety of defense mechanisms in the XY plane. The Z-coordinates of the plot are measures of the difference between a performance of the attack mitigation system implemented using the systems and methods described herein, compared to a corresponding existing defense strategy, for a given attack and existing defense strategy pair in the XY plane. The attack mitigation system disclosed herein is seen to provide overall better performance than existing defense mechanisms.

From the box plots it is evident that, apart from the attack agnostic nature, the performance in terms of the accuracy improvement is statistically better than that of existing defenses, thereby giving a double advantage.

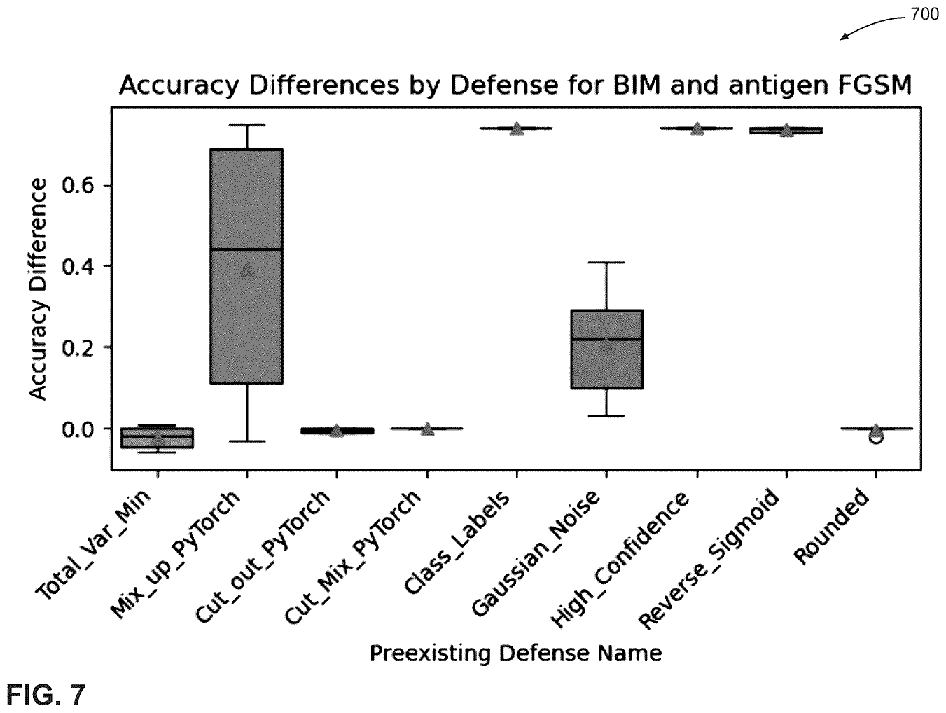

FIG. 7 is a graph 700 presenting accuracy differences by defense for a basic iterative method (BIM) and an FGSM attack mitigation method. The accuracy differences are presented using box plots that measure the accuracy differences by defense.

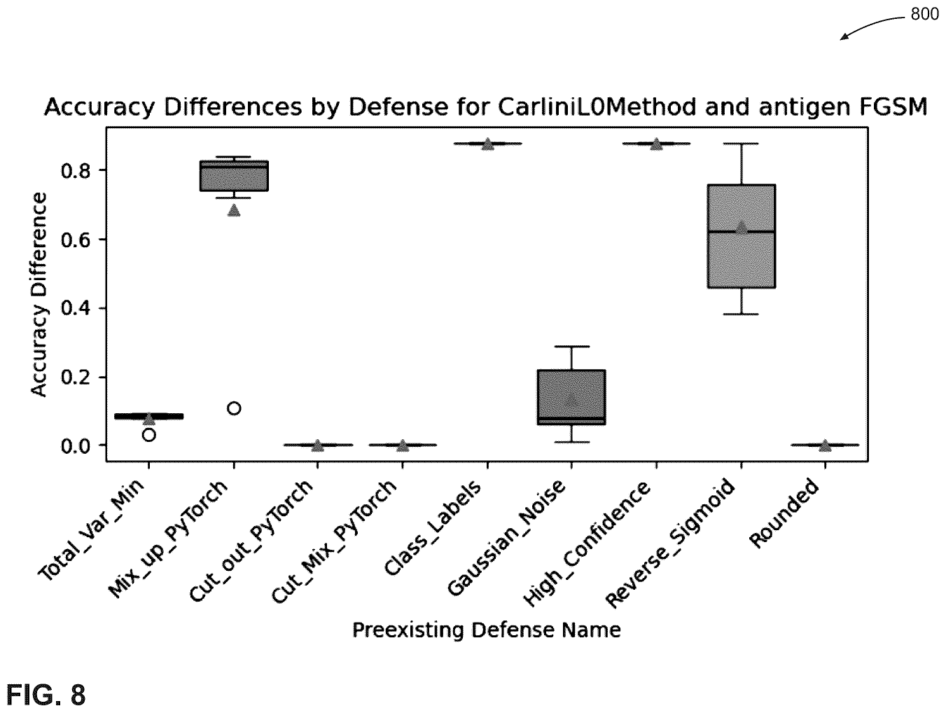

FIG. 8 is a graph 800 presenting accuracy differences by defense for a Carlini LO method and an FGSM attack mitigation method. The accuracy differences are presented using box plots that measure the accuracy differences by defense.

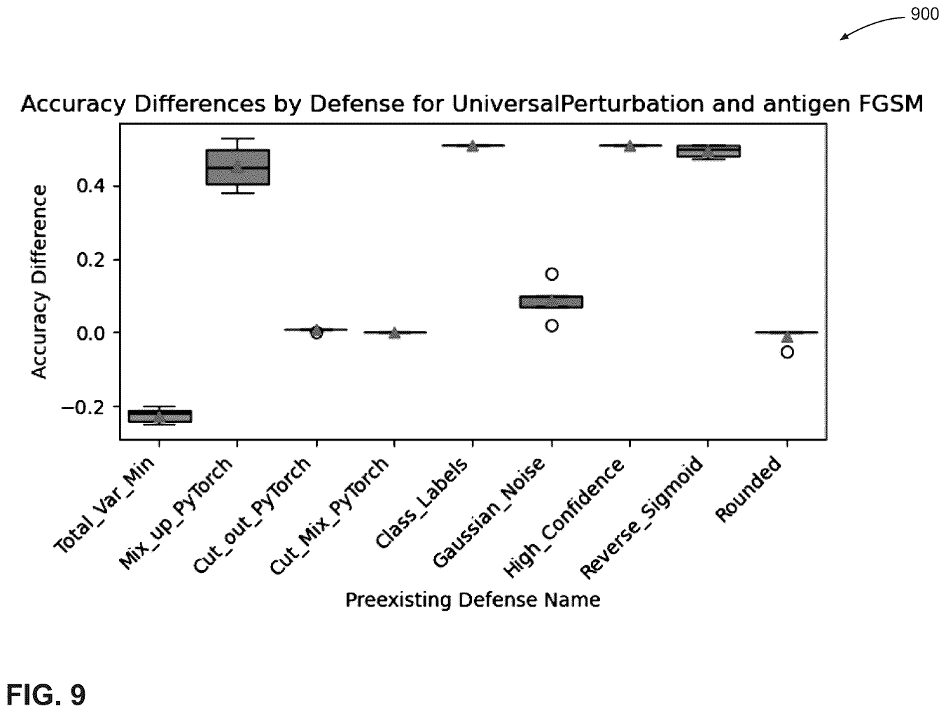

FIG. 9 is a graph 900 presenting accuracy differences by defense for a universal perturbation and an FGSM attack mitigation method. The accuracy differences are presented using box plots that measure the accuracy differences by defense.

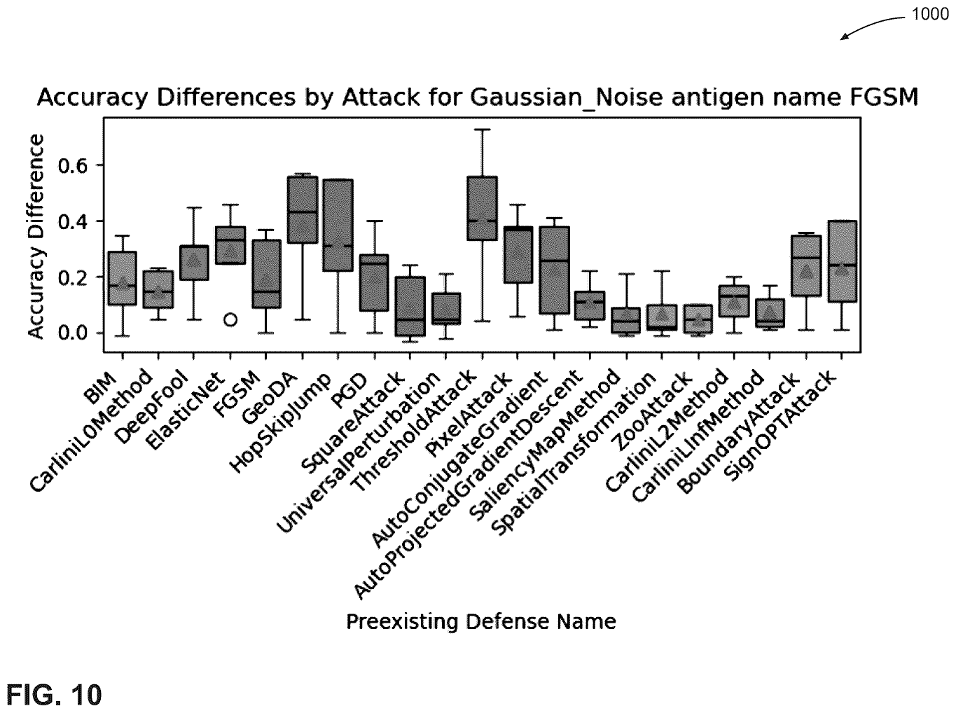

FIG. 10 is a graph 1000 presenting accuracy differences for different preexisting defenses. FIG. 10 presents accuracy differences by attack for Gaussian noise, antigen name FGSM. In graph 1000, the traditional defense mechanism is Gaussian Noise, while the antigen mechanism applied is FGSM.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving data to be analyzed by an artificial intelligence (AI) system, wherein the data is perturbed by an attack; and
performing a counterattack on the data as a part of an attack mitigation, wherein the counterattack comprises further perturbing the data.

2. The method of claim 1, wherein the counterattack is a fast gradient sign method (FGSM) attack.

3. The method of claim 1, wherein the counterattack increases a loss on one or more incorrect labels in the data, thereby compensating for mislabeling in the data caused by the perturbation due to the attack.

4. The method of claim 1, wherein the data is known to be perturbed by the attack, but a nature of the attack is unknown.

5. The method of claim 1, further comprising detecting the perturbation due to the attack in the data.

6. The method of claim 5, wherein the counterattack is performed responsive to the detecting.

7. The method of claim 1, wherein the counterattack is agnostic to a nature or a type of the attack.

8. The method of claim 1, wherein the counterattack reduces or eliminates an effect of the perturbation.

9. A method comprising:
receiving data to be analyzed by an artificial intelligence (AI) system running on a computing system;
analyzing the data to determine a presence of a perturbation or an attack;
responsive to determining the presence, performing an attack mitigation; and
inputting the data after the attack mitigation to the AI system for the analysis.

10. The method of claim 9, wherein the attack mitigation comprises further perturbing the data via a counterattack.

11. The method of claim 10, wherein the counterattack is a fast gradient sign method (FGSM) attack.

12. The method of claim 10, wherein the counterattack increases a loss on one or more incorrect labels in the data, thereby compensating for mislabeling in the data caused by the perturbation or attack.

13. The method of claim 9, wherein the attack mitigation process is agnostic to a nature or a type of the perturbation or attack.

14. A non-transitory computer-readable medium storing executable code that, when executed by a computing device, causes the computing device to:
receive data to be analyzed by an artificial intelligence (AI) system, wherein the data is perturbed by an attack; and
perform a counterattack on the data as a part of an attack mitigation, wherein the counterattack comprises further perturbing the data.

15. The non-transitory computer-readable medium of claim 14, wherein the counterattack is a fast gradient sign method (FGSM) attack.

16. The non-transitory computer-readable medium of claim 14, wherein the counterattack increases a loss on one or more incorrect labels in the data, thereby compensating for mislabeling in the data caused by the perturbation due to the attack.

17. The non-transitory computer-readable medium of claim 14, wherein the data is known to be perturbed by the attack, but a nature of the attack is unknown.

18. The non-transitory computer-readable medium of claim 14, further wherein the computing device detects the perturbation due to the attack in the data.

19. The non-transitory computer-readable medium of claim 18, wherein the counterattack is performed responsive to the detecting.

20. The non-transitory computer-readable medium of claim 14, wherein the counterattack is agnostic to a nature or a type of the attack.

21. The non-transitory computer-readable medium of claim 14, wherein the counterattack reduces or eliminates an effect of the perturbation.
